(19) United States
(12) Patent Application Publication
(10) Pub. No.: US 2023/0068050 A1
(43) Pub. Date: Mar. 2, 2023

(54) LIFT ARM FOR A THREE-POINT HITCH

(71) Applicant: CNH INDUSTRIAL AMERICA LLC, New Holland, PA (US)

(72) Inventors: Chad Sietsema, Moorhead, MN (US); John T. Rasset, Barnesville, MN (US)

(73) Assignee: CNH INDUSTRIAL AMERICA LLC, (omitted)

(21) Appl. No.: 17/463,332

(22) Filed: Aug. 31, 2021

(51) Int. Cl. A01B 59/00

(52) U.S. Cl. CPC A01B 59/002; A01B 59/066

(57) ABSTRACT

A lift arm for a three-point hitch includes a central body. The central body includes a connecting member and a first rib extending away from a surface of the connecting member along a lateral axis. The central body also includes a second rib extending away from the surface of the connecting member along the lateral axis. A channel is formed by the connecting member, the first rib, and the second rib.

### BACKGROUND

The present disclosure relates generally to a lift arm for a three-point hitch.

Certain work vehicles, such as tractors, include a three-point hitch configured to engage a corresponding hitch of a towed implement. Certain three-point hitches include two lower lift arms and an upper link. Each lower lift arm includes an opening configured to receive a corresponding lower hitch pin of the towed implement hitch, and the upper link includes an opening configured to receive a corresponding upper hitch pin of the towed implement hitch. Each hitch pin may be disposed within a corresponding opening to couple the towed implement to the work vehicle.

The lift arms (e.g., lower lift arms) of the three-point hitch may be subjected to a number of loads and bending moments while the work vehicle moves the towed implement via the three-point hitch. For example, the lower lift arms may be subjected to a tension load due to the towed implement being pulled behind the work vehicle. Lateral movement of the towed implement may also impart a lateral bending moment on the lower lift arms. Additionally, the lower lift arms may be subjected to another bending moment from raising the towed implement off the ground. To support the loads and bending moments, each lower lift arm may be formed from a substantial amount of material, thereby increasing the cost of the three-point hitch.

### BRIEF DESCRIPTION

In certain embodiments, a lift arm for a three-point hitch includes a central body. The central body includes a connecting member and a first rib extending away from a surface of the connecting member along a lateral axis. The central body also includes a second rib extending away from the surface of the connecting member along the lateral axis. A channel is formed by the connecting member, the first rib, and the second rib.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle coupled to an implement via a three-point hitch;

FIG. 2 is a front perspective view of an embodiment of a lower lift arm that may be employed within the three-point hitch of FIG. 1;

FIG. 3 is a rear perspective view of the lower lift arm of FIG. 2; and

FIG. 4 is a cross-sectional view of the lower lift arm of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

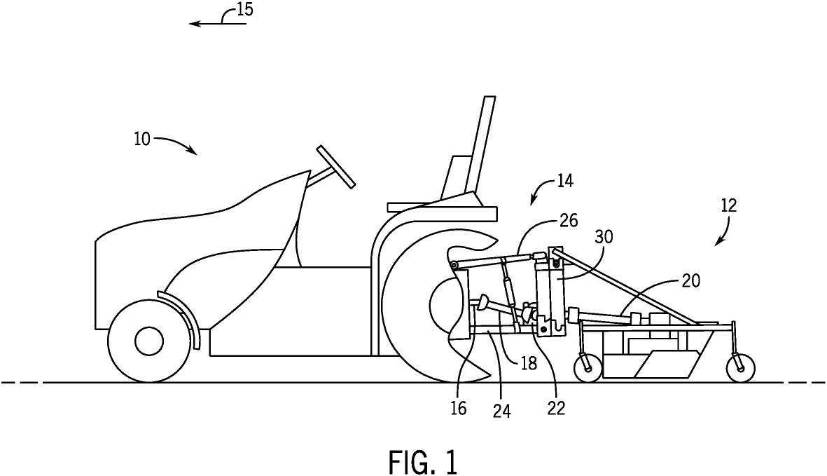

FIG. 1 is a side view of an embodiment of a work vehicle 10 coupled to an implement 12 via a three-point hitch 14. The work vehicle 10 is configured to tow the implement 12 (e.g., through a field) along a direction of travel 15. In the illustrated embodiment, the work vehicle 10 is a tractor. However, in other embodiments, the work vehicle may be any other suitable type of work vehicle configured to tow an implement, such as a harvester or a sprayer. Furthermore, in the illustrated embodiment, the implement 12 is a powered implement, such as a spreader, a rotary mower, or a rotary tiller. The implement is powered by a power-take off (PTO) shaft 16 of the work vehicle 10. An engine of the work vehicle 10 drives the PTO shaft to rotate (e.g., via a transmission, a PTO drive system, etc.), and rotation of the PTO shaft drives rotation of one or more rotary components of the implement 12, such as a rotary spreader system, mower blades, or a rotary tillage assembly. In the illustrated embodiment, the PTO shaft 16 includes a telescoping portion 18 configured to facilitate adjustment of a length of the PTO shaft 16 to accommodate different types of powered implements. However, in other embodiments, the work vehicle may have a non-telescoping PTO shaft. As illustrated, the PTO shaft 16 of the work vehicle 10 is coupled to a corresponding shaft 20 of the implement 12, and the corresponding shaft 20 of the implement 12 is configured to drive rotation of the rotary component(s) of the implement 12. The PTO shaft 16 and the corresponding shaft 20 of the implement 12 are coupled to one another via a connection assembly 22. The connection assembly 22 may include any suitable device(s) configured to couple the PTO shaft 16 to the corresponding shaft 20, such that rotation of the PTO shaft 16 drives the corresponding shaft 20 to rotate. While the implement 12 is a powered implement in the illustrated embodiment, in other embodiments, the implement may be a non-powered implement, such as a vertical tillage implement, a primary tillage implement, a seeding implement, or a finishing implement. In such embodiments, the PTO shaft of the work vehicle may not be coupled to a corresponding shaft of the implement, or the work vehicle may not include a PTO shaft.

In the illustrated embodiment, the implement 12 is coupled to the work vehicle 10 via the three-point hitch 14 of the work vehicle 10. The three-point hitch 14 includes two lower lift arms 24 and an upper link 26. The two lower lift arms 24 and the upper link 26 are coupled (e.g., rotatably coupled) to a chassis of the work vehicle 10. In certain embodiments, one or more actuators are coupled to the lower lift arms and configured to drive the lower lift arms to rotate relative to the chassis of the work vehicle. Each lower lift arm 24 includes an opening configured to receive a corresponding lower hitch pin of the implement 12, and the upper link 26 includes an opening configured to receive a corresponding upper hitch pin of the implement 12. In certain embodiments, each hitch pin of the implement 12 may be disposed within a corresponding opening to couple the implement 12 to the work vehicle 10.

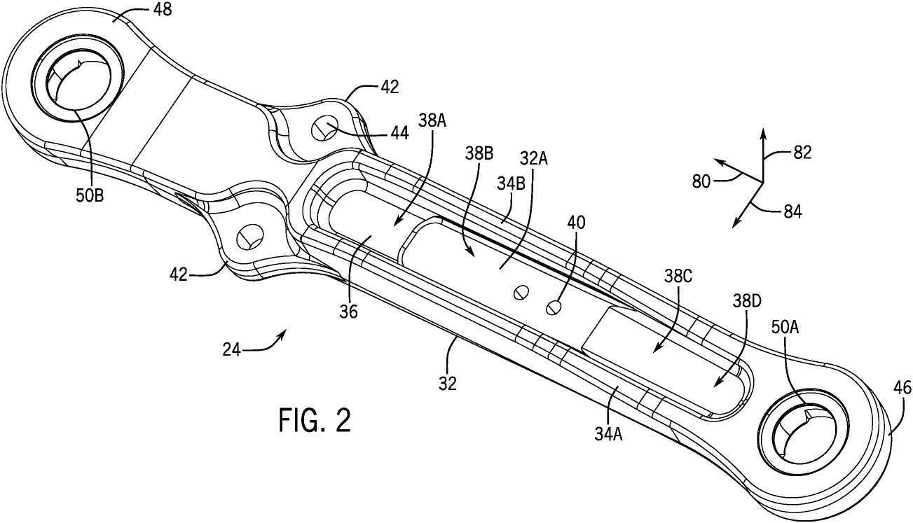

FIG. 2 is a front perspective view of an embodiment of a lower lift arm 24 that may be employed within the three-point hitch of FIG. 1. In the illustrated embodiment, the lower lift arm 24 includes a central body 32 extending substantially along a length of the lower lift arm 24 (e.g., extent of the lower lift arm 24 along a longitudinal axis 80). For example, the central body 32 may extend between one or more eye links 42 at a first longitudinal end and an opening 50A at a second longitudinal end. The central body 32 may include a number of ribs, such as ribs 34A, 34B, positioned symmetrically about a vertical center of the central body 32. However, in other embodiments, the ribs 34A, 34B may be asymmetrical about the vertical center of the central body 32. The ribs 34A, 34B may be formed at opposite vertical ends of the central body 32 and may extend away from a surface 32A of the central body 32 along a vertical axis 84. The ribs 34A, 34B may reinforce the lower lift arm 24 (e.g., substantially reduce bending about the vertical axis 84), and each rib may extend along the central body 32 of the lower lift arm 24. The first rib 34A may extend longitudinally along (e.g., along the longitudinal axis 80) the lower lift arm 24 and may be formed at a first vertical end of the central body 32. The second rib 34B may also extend longitudinally along the lower lift arm 24 and may be formed at a second vertical end of the central body 32, opposite the first vertical end. The thickness of each rib may be particularly selected to enable the lower lift arm 24 to transfer loads (e.g., a maximum expected load) to the work vehicle chassis and to reduce bending of the lower lift arm 24 about the vertical axis 84. While the lower lift arm 24 has two ribs in the illustrated embodiment, in other embodiments, the lower lift arm may have more or fewer ribs (e.g., 1, 3, 4, 5, 6, or more). While the ribs are substantially parallel to the longitudinal axis 80 in the illustrated embodiment, at least one rib may be oriented at an angle relative to the longitudinal axis 80. For example, at least one rib may be inclined relative to the longitudinal axis 80 from the first end 46 to the second end 48 of the lower lift arm 24.

The ribs 34A, 34B are connected by a connecting member 36, and the ribs and the connecting member form a channel 38 between the ribs. As illustrated, the channel 38 extends at least partially through the central body 32 along the longitudinal axis 80. The shape of the connecting member 36 forms portions, such as portions 38A, 38B, 38C, and 38D, within the channel, and each portion of the channel 38 has a corresponding depth (e.g., extent of the channel 38 along the lateral axis 82). For example, the first portion 38A may be formed at least partially through the central body 32 and may have a depth greater than any other portion of the channel 38. As such, the ribs 34A, 34B may extend farther away from the section of the connecting member 36 positioned at the first portion 38A than any other section of the connecting member. In certain embodiments, any portion of the channel 38 may have a varying depth. Additionally or alternatively, any portion of the channel 38 may have a substantially uniform (e.g., substantially constant) depth. The depths of the channel 38 may be particularly selected to reduce the amount of material used to form the lower lift arm 24. As such, a cost of manufacturing the lower lift arm 24 may be reduced. While the channel 38 has four portions in the illustrated embodiment, the channel 38 may include more or fewer portions. For example, the channel 38 may include a single portion having a substantially constant depth along the lateral axis 82.

The section of the connecting member 36 at the second portion 38B of the channel 38 may have a number of apertures 40. The apertures 40 may receive fasteners to couple another component of the three-point hitch to the lower lift arm 24. For example, the fasteners may couple a wear block to the lower lift arm 24. While two apertures are shown in the illustrated embodiment, more or fewer apertures may be formed through the lower lift arm 24. For example, no apertures may be formed through the lower lift arm 24 in the channel 38. In the illustrated embodiment, the depth of the second portion 38B is less than the depth of the first portion 38A. As such, the section of the connecting member 36 positioned at the second portion 38B may form a raised plateau. In the illustrated embodiment, the second portion 38B may have a varying depth. For example, the depth of the second portion 38B may increase from a minimum depth of the second portion 38B adjacent the third portion 38C to a maximum depth of the second portion 38B adjacent the first portion 38A. While the illustrated embodiment has a varying depth for the second portion 38B, a configuration of the second portion 38B may differ in other embodiments. For example, the second portion 38B may have a constant depth along the vertical axis 84. In the illustrated embodiment, the depth of the second portion 38B may vary uniformly along the longitudinal axis 80, however, in other embodiments, the depth of the second portion 38B may have non-uniform variations along the longitudinal axis 80.

In the illustrated embodiment, the third portion 38C may also have a varying depth. For example, the third portion 38C may have a maximum depth adjacent the second portion 38B and a minimum depth adjacent the fourth portion 38D. Additionally or alternatively, the depth of the third portion 38C may vary uniformly along a length (e.g., along the longitudinal axis 80) of the third portion 38C in other embodiments. In the illustrated embodiment, the fourth portion 38D may have a uniform depth. The depth of the fourth portion 38D may be less than the depths of the other portions 38A, 38B, 38C. In other embodiments, the depth of the fourth portion 38D may vary along longitudinal axis 80. The ribs 34A, 34B and the connecting member 36 may form a C-shaped beam along a portion of the central body 32. In certain embodiments, the C-shaped beam may substantially reduce compression of the lower lift arm 24 (e.g., a reduction in the distance along the longitudinal axis 80 between a first end 46 and a second end 48) due to a compression load applied to the lower lift arm 24 by the towed implement.

In the illustrated embodiment, the lower lift arm 24 includes one or more eye links 42 formed adjacent the central body 32 of the lower lift arm 24. For example, the one or more eye links 42 may be formed at a first longitudinal end of the central body 32. As illustrated, the eye links 42 extend outwardly along the vertical axis 84 from a vertical center of the lower lift arm, and each eye link 42 has a substantially semi-circular shape. As illustrated, the eye links 42 are formed on opposite vertical ends of the lower lift arm 24. Each eye link 42 includes an aperture 44 formed therethrough. The aperture 44 may receive a fastener, such as a pin, to couple the lower lift arm 24 to an actuator. The actuator is configured to drive the lower lift arm to move upwardly and downwardly to control the position of the towed implement hitch. In the illustrated embodiment, the lower lift arm 24 includes two eye links 24, and one eye link (e.g., the upper eye link) may be coupled to the actuator. As such, the lower lift arm 24 may be reversible (e.g., by rotating the lower lift arm 180 degrees about the longitudinal axis 80), thereby enabling the lower lift arm to be used for either the left lower lift arm or the right lower lift arm of the three-point hitch. Accordingly, the design and manufacturing cost of the lower lift arm may be reduced (e.g., as compared to designing and manufacturing separate left and right lower lift arms). While the lower lift arm 24 includes two eye links 42 in the illustrated embodiment, the lower lift arm 24 may include more or fewer eye links 42 (e.g., 0, 1, 3, 4, or more), and each eye link may be configured to receive a corresponding fastener. Furthermore, each eye link may be formed at any suitable location along the longitudinal extent of the lower lift arm.

The lower lift arm 24 also has openings 50A, 50B formed at opposite longitudinal ends of the lower lift arm 24. For example, the first end 46 and the second end 48 of the lower lift arm 24 may have respective openings 50A, 50B. The opening 50A at the first end 46 may receive a pin configured to couple the lower lift arm 24 to the chassis of the work vehicle. The opening 50B at the second end 48 of the lower lift arm 24 may receive a hitch pin configured to couple the lower lift arm 24 to the towed implement. In the illustrated embodiment, the openings 50A, 50B extend through the lower lift arm 24. While two openings are shown in the illustrated embodiments, the lower lift arm 24 may include more or fewer openings. For example, one or more of the openings may be replaced with an integrated pin such that the lower lift arm 24 and the integrated pin form a single element.

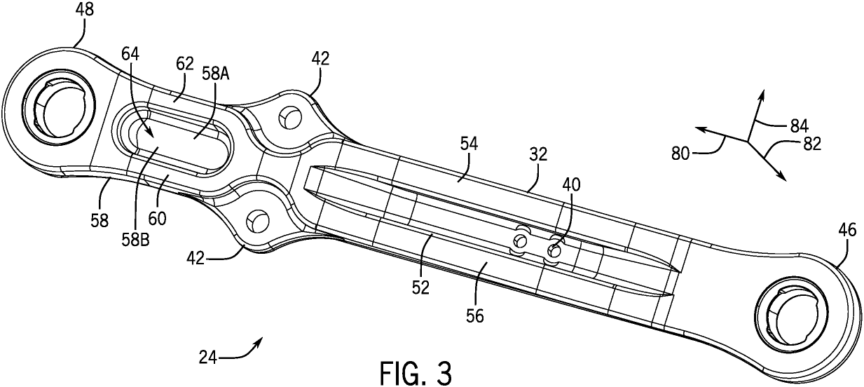

FIG. 3 is a rear perspective view of the lower lift arm 24 of FIG. 2. The central body 32 has a slot 52 formed at least partially through the connecting member 36. The apertures 40 are aligned with the slot 52 and extend through the connecting member 36. As illustrated, the connecting member has ridges 54, 56 that form the slot 52. The slot 52 may have a narrower width (e.g., extent along the vertical axis 84) than the channel formed on the opposite lateral side of the lower lift arm 24. As such, the ridges 54, 56 may have a larger width (e.g., extent along the vertical axis 84) than the ribs formed on the opposite lateral side of the lower lift arm 24. In certain embodiments, the slot 52 may at least partially overlap the second portion of the channel along the longitudinal axis 80. For example, a first end of the slot 52 may be located at a similar longitudinal position as a first end of the second portion of the channel, and a second end of the slot 52 may be located at a similar longitudinal position as a second end of the second portion of the channel. In some embodiments, the slot 52 may have a tapered portion at either longitudinal end. For example, the longitudinal ends of the slot 52 may have sloped surfaces extending downwardly to a depth of the slot 52. Additionally or alternatively, the slot 52 may have a uniform depth between the longitudinal ends. While the illustrated embodiment shows a single slot, the lower lift arm 24 may include more or fewer slots. For example, the slot 52 may be omitted from the lower lift arm 24 in other embodiments. Additionally or alternatively, the slot 52 may be oriented differently than shown in the illustrated embodiment. For example, the slot 52 may be oriented at an angle relative to the longitudinal axis 80.

In certain embodiments, the ridges 54, 56 may reduce expansion of the lower lift arm 24 (e.g., an increase in the distance along the longitudinal axis 80 between the first end 46 and the second end 48) due to a tension load applied to the lower lift arm 24 by the towed implement. The thickness of each ridge 54, 56 may be particularly selected to enable the lower lift arm 24 to transfer loads (e.g., a maximum expected load) to the work vehicle chassis and to reduce bending of the lower lift arm 24 about the vertical axis 84. The depth of the slot 52 may be particularly selected to reduce an amount of material used in manufacturing the lower lift arm 24. As such, a cost of manufacturing the lower lift arm 24 may be reduced due to the presence of the slot 52.

The lower lift arm 24 may also include an intermediate portion 58 disposed between the eye links 42 and the second end 48 of the lower lift arm 24. In certain embodiments, the intermediate portion 58 includes one or more outer ribs 60, 62 that form a recess 64 within the intermediate portion 58. For example, the intermediate portion 58 may include two outer ribs 60, 62 that are formed at opposite vertical ends of the intermediate portion 58 and extend away from a surface 58A of the connecting member 58B along the lateral axis 82. As illustrated, the outer ribs 60, 62 extend longitudinally (e.g., along the longitudinal axis 80) along the lower lift arm 24 and/or longitudinally along the intermediate portion 58. The outer ribs 60, 62 may be connected by additional members extending across the recess 64 (e.g., along the vertical axis 84). The members may extend between the outer ribs 60, 62 and connect to the outer ribs 60, 62. In certain embodiments, the outer ribs 60, 62 may reduce expansion of the lower lift arm 24 due to tension loads applied to the lower lift arm 24. The thickness of each outer rib 60, 62 may be particularly selected to enable the lower lift arm to transfer loads (e.g., a maximum expected load) from the towed implement and maintain structural integrity of the three-point hitch. In the illustrated embodiment, two outer ribs are shown, however, the lower lift arm 24 may include more or fewer outer ribs in other embodiments. Additionally or alternatively, while the outer ribs 60, 62 are substantially parallel to the longitudinal axis 80 in the illustrated embodiment, at least one outer rib may be oriented at an angle relative to the longitudinal axis in other embodiments.

The recess 64 may be a substantially rectangular cutout portion formed in the intermediate portion 58. As illustrated, the recess 64 extends partially through the intermediate portion 58. In the illustrated embodiment, the recess 64 has a varying depth. For example, the connecting member 58B has a tapered surface that forms a base of the recess 64, and the depth of the recess increases from a minimum depth at a first longitudinal end adjacent the second end 48 of the lower lift arm 24 to a maximum depth at a second longitudinal end adjacent the eye links 42 of the lower lift arm. Additionally or alternatively, the recess 64 may have a substantially uniform (e.g., substantially constant) depth. The depth of the recess 64 may be particularly selected to reduce an amount of material used in manufacturing the lower lift arm 24. As such, a cost of manufacturing the lower lift arm 24 may be reduced due to the presence of the recess 64.

In certain embodiments, the lower lift arm 24 (e.g., including the central body 32, the intermediate portion 58, the one or more eye links 42, the first end 46 and the second end 48) may be formed via a forging process. For example, heated metal (e.g., steel, iron, etc.) may be subjected to compressive forces in a die. After the metal cools and hardens, the lower lift arm 24 may be removed from the die and the opening/apertures may be formed (e.g., via a drilling process, etc.) in the lower lift arm. Accordingly, the lower lift arm may be formed as a single forged element, thereby reducing the manufacturing cost of the lower lift arm (e.g., as compared to a lower lift arm formed entirely by a machining process). In certain embodiments, the lower lift arm 24 may be formed from steel via the forging process disclosed above. Additionally or alternatively, the lower lift arm 24 (e.g., including the central body 32, the intermediate portion 58, the one or more eye links 42, the first end 46, and the second end 48) may be formed via a casting process. For example, molten metal (e.g., steel, iron, etc.) may be poured into a mold cavity having the shape of the lower lift arm 24. After the metal cools and hardens, the lower lift arm 24 may be removed from the mold cavity and the opening/apertures may be formed (e.g., drilled, etc.) in the lower lift arm 24. Accordingly, the lower lift arm may be formed as a single cast element, thereby reducing the manufacturing cost of the lower lift arm.

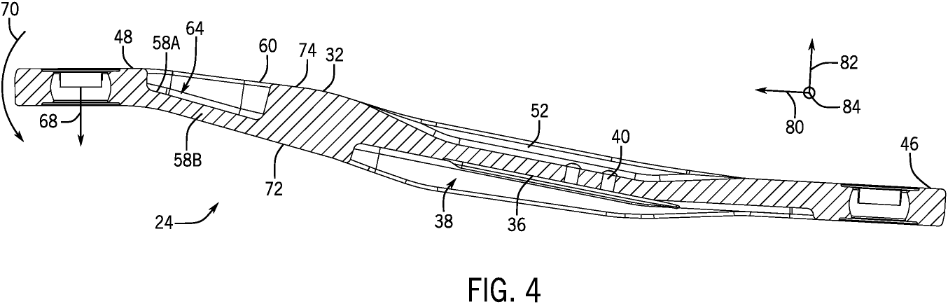

FIG. 4 is a cross-sectional view of the lower lift arm 24 of FIG. 2. The second end 48 of the lower lift arm 24 may be offset from the first end 46 along the vertical axis 84. In certain embodiments, the shape of the central body and the intermediate portion may be particularly selected to enable the lower lift arm 24 to clear certain component(s) (e.g., component(s) of the towed implement, component(s) of the three-point hitch, component(s) of the work vehicle, and so forth). In the illustrated embodiment, the channel 38 has a varying depth along the longitudinal axis 80 of the lower lift arm 24. As illustrated, the connecting member 36 is positioned between the channel 38 and the slot 52. The apertures 40 extend through the connecting member 36 and terminate at the slot 52. For example, the apertures 40 extend along the lateral axis 82 through the connecting member 36 and from the slot 52 to the channel 38. Any apertures or openings formed through the lower lift arm 24 may result in stress concentrations around the apertures due to loads and/or bending moments exerted on the lower lift arm 24. Accordingly, the apertures 40 may be disposed through a lower stressed portion of the lower lift arm 24 to reduce stress concentrations (e.g., maximum stress levels) around the apertures 40. In some embodiments, the connecting member 36 may have a substantially uniform (e.g., substantially constant) thickness.

During use of the lower lift arm 24, a side load 68 may be placed on the lower lift arm 24. The side load 68 may result in a bending moment 70 that places portions of the lower lift arm 24 in tension and other portions of the lower lift arm 24 in compression. For example, the bending moment 70 may place an inner side 72 of the lower lift arm 24 in compression. As discussed herein, the ribs 34A, 34B may resist the compression and/or may reduce an amount of lower lift arm deflection due to the side load 68 and the resulting bending moment 70. The bending moment 70 may place an outer side 74 of the lower lift arm 24 in tension. The outer ribs 60, 62 and/or the ridges 54, 56 may resist the expansion and/or may reduce an amount of lower lift arm deflection due to the side load 68 and the resulting bending moment 70.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]...” or “step for [perform]ing [a function]...”, it is intended that such elements are to be interpreted under 35 U.S.C. 112(f). However, for any claims containing elements designated in any other manner, it is intended that such elements are not to be interpreted under 35 U.S.C. 112(f).

1. A lift arm for a three-point hitch, comprising:
a central body comprising:
a connecting member;
a first rib extending away from a surface of the connecting member along a lateral axis; and
a second rib extending away from the surface of the connecting member along the lateral axis;
wherein a channel is formed by the connecting member, the first rib, and the second rib.

2. The lift arm of claim 1, wherein the lift arm is a single forged element or a single cast element.

3. The lift arm of claim 1, comprising an intermediate portion having:
a first rib extending away from a surface of a second connecting member along the lateral axis; and
a second rib extending away from the surface of the second connecting member along the lateral axis.

4. The lift arm of claim 3, wherein the surface of the connecting member of the central body and the surface of the connecting member of the intermediate portion face substantially opposite lateral directions.

5. The lift arm of claim 1, comprising at least one eye link configured to couple to an actuator of the three-point hitch.

6. The lift arm of claim 1, comprising a first opening disposed at a first end of the lift arm, wherein the first opening is configured to couple the lift arm to a work vehicle.

7. The lift arm of claim 6, comprising a second opening disposed at a second end of the lift arm, wherein the second opening is configured to couple the lift arm to an implement.

8. A lift arm for a three-point hitch, comprising:
at least one eye link configured to couple to an actuator;
an opening configured to couple the lift arm to a work vehicle; and
a central body extending between the at least one eye link and the opening, wherein the central body has a channel formed between a top rib and a bottom rib.

9. The lift arm of claim 8, wherein the central body has a slot formed between a top ridge and a bottom ridge.

10. The lift arm of claim 9, wherein the channel is formed on a first lateral side of the central body, and the slot is formed on a second lateral side of the central body, opposite the first lateral side.

11. The lift arm of claim 8, wherein the top rib extends away from a surface of a connecting member along a lateral axis.

12. The lift arm of claim 8, wherein the channel has a varying depth along the longitudinal axis.

13. The lift arm of claim 8, wherein the central body has at least one aperture extending laterally to the channel.

14. A lift arm for a three-point hitch, comprising:
at least one eye link configured to couple to an actuator;
a first opening configured to couple the lift arm to a work vehicle;
a second opening configured to couple the lift arm to an implement;
a central body extending between the at least one eye link and the second opening, wherein the central body comprises:
a first rib;
a second rib; and
a channel disposed between the first rib and the second rib; and
an intermediate portion configured to extend between the at least one eye link and the first opening, wherein the intermediate portion comprises:
a first rib;
a second rib; and
a recess disposed between the first rib and the second rib.

15. The lift arm of claim 14, wherein the central body and the intermediate portion are formed as a single forged element.

16. The lift arm of claim 14, wherein the central body, the intermediate portion, and the at least one eye link are formed as a single forged element or a single cast element.

17. The lift arm of claim 14, wherein the central body has:
a plurality of ridges;
a slot formed between the plurality of ridges, wherein the plurality of ridges extend away from a surface of a connecting member along the lateral axis.

18. The lift arm of claim 17, wherein the first rib of the central body extends away from a second surface of the connecting member along the lateral axis.

19. The lift arm of claim 14, wherein the first rib of the central body extends away from a surface of a connecting member along the lateral axis.

20. The lift arm of claim 14, wherein the first rib of the central body and the first rib of the intermediate portion extend in opposite lateral directions..
